(19) United States
(12) Patent Application Publication
(10) Pub. No.: US 2017/0280364 A1
(43) Pub. Date: Sep. 28, 2017

(54) Mobile Terminal Control Method and Mobile Terminal

(71) Applicant: Huawei Technologies Co., Ltd., Shenzhen (CN)

(72) Inventors: Henghui Lu, Beijing (CN); Shuiping Long, Beijing (CN)

(21) Appl. No.: 15/512,135

(22) PCT Filed: Sep. 17, 2014
(86) PCT No.: PCT/CN2014/086734

§ 371 Date: Mar. 17, 2017

(51) Int. Cl. H04W 36/14; H04W 36/36; H04W 36/18; H04W 36/30

(52) U.S. Cl. CPC H04W 36/14; H04W 36/30; H04W 36/36; H04W 36/18

(57) ABSTRACT

A mobile terminal control method and a mobile terminal are provided. The control method includes receiving at least one network message in a current time period, where the at least one network message is sent by at least one network device, obtaining, according to the network message received in the current time period, a network identifier of the network message received in the current time period, and determining whether a correspondence between the current time period and the network identifier of the network message received in the current time period complies with a correspondence stored in a database.

### CROSS-REFERENCE TO RELATED APPLICATIONS

This application is a U.S. National Stage of International Patent Application No. PCT/CN2014/086734 filed on Sep. 17, 2014, which is hereby incorporated by reference in its entirety.

### TECHNICAL FIELD

Embodiments of the present disclosure relate to the field of communications technologies, and in particular, to a mobile terminal control method and a mobile terminal.

### BACKGROUND

With development of mobile technologies, various mobile terminals become increasingly popular. For example, common smartphones are applied to various aspects of lives of people. Currently, in addition to obtaining a communications service using a mobile terminal, a user further expects the mobile terminal to provide different user-friendly services in different usage scenarios. For example, the user needs the mobile terminal to remain mute when a usage scenario of the mobile terminal is a conference scenario. However, due to negligence of the user, after entering the conference scenario, the user forgets to switch the mobile terminal from a ringing mode to a mute mode, and when receiving a message, the mobile terminal still makes a sound for reminding, thereby bringing inconvenience to the user. In this case, after entering the conference scenario, the user expects the mobile terminal to adaptively switch from the ringing mode to the mute mode. Further, the user usually stores some private information in the mobile terminal, and disclosure of the private information in the mobile terminal causes an economic loss and a security problem to the user when the mobile terminal is stolen. If the mobile terminal can intelligently learn that the mobile terminal is stolen, and automatically perform an anti-theft operation, security of the user may be effectively ensured.

A prerequisite for an adaptive operation of a mobile terminal is to accurately learn of a usage scenario corresponding to the adaptive operation. To enable the mobile terminal to learn of a current usage scenario, a user of the mobile terminal usually enables a camera of the mobile terminal in order to capture an image of the current usage scenario. Then, the mobile terminal learns of the current usage scenario according to the captured image, and performs an adaptive operation. However, when the prior art is used to enable a mobile terminal to learn of a usage scenario, a user of the mobile terminal needs to actively enable a camera of the mobile terminal, the mobile terminal cannot automatically determine the usage scenario in a timely manner, and the enabled camera further increases power consumption of the mobile terminal.

### SUMMARY

Embodiments of the present disclosure provide a mobile terminal control method and a mobile terminal, used to adaptively perform a corresponding control operation according to a network message received in real time and a correspondence stored in a database in order to bring convenience to a user.

According to a first aspect, an embodiment of the present disclosure provides a mobile terminal control method, including receiving, by a mobile terminal, at least one network message in a current time period, where the at least one network message is sent by at least one network device, obtaining, by the mobile terminal according to the network message received in the current time period, a network identifier of the network message received in the current time period, determining, by the mobile terminal, whether a correspondence between the current time period and the network identifier of the network message received in the current time period complies with a correspondence stored in a database, where the correspondence stored in the database includes a correspondence between a time period and a network identifier that are of a network message received by the mobile terminal before the current time period, and performing, by the mobile terminal, a corresponding control operation according to a determining result.

With reference to the first aspect, in a first implementation manner, the network device includes a mobile communications base station, and the network identifier includes a cell identity (Cell ID).

With reference to the first aspect or the first implementation manner, in a second implementation manner, the network device includes a WI-FI access point device, and the network identifier includes a service set identifier (SSID).

With reference to any one of the first aspect to the second implementation manner of the first aspect, in a third implementation manner, the network device includes a BLUETOOTH pairing device, and the network identifier includes BLUETOOTH device identification.

With reference to any one of the first aspect to the third implementation manner of the first aspect, in a fourth implementation manner, performing, by the mobile terminal, a corresponding control operation according to a determining result includes determining, by the mobile terminal, whether the mobile terminal is in a missing claiming state by querying a network server if the determining result is that the correspondence between the current time period and the network identifier of the network message received in the current time period does not comply with the correspondence stored in the database, and performing, by the mobile terminal, an anti-theft operation if the mobile terminal is in the missing claiming state.

With reference to any one of the first aspect to the third implementation manner of the first aspect, in a fifth implementation manner, performing, by the mobile terminal, a corresponding control operation according to a determining result includes performing, by the mobile terminal, an anti-theft operation if the determining result is that the correspondence between the current time period and the network identifier of the network message received in the current time period does not comply with the correspondence stored in the database.

With reference to any one of the first aspect to the third implementation manner of the first aspect, in a sixth implementation manner, performing, by the mobile terminal, a corresponding control operation according to a determining result includes performing, by the mobile terminal, identity authentication for a holder of the mobile terminal if the determining result is that the correspondence between the current time period and the network identifier of the network message received in the current time period does not comply with the correspondence stored in the database, and performing, by the mobile terminal, an anti-theft operation if authentication fails.

With reference to any one of the first aspect to the third implementation manner of the first aspect, in a seventh implementation manner, before the mobile terminal receives the current network information, the control method further includes determining, by the mobile terminal, whether the mobile terminal has a network information receiving capability, performing, by the mobile terminal, identity authentication for a holder of the mobile terminal if the mobile terminal does not have the network information receiving capability, and performing, by the mobile terminal, an anti-theft operation if authentication fails.

With reference to the sixth implementation manner or the seventh implementation manner of the first aspect, in an eighth implementation manner, the identity authentication includes at least one of password authentication, pattern unlocking, or biometric feature recognition.

With reference to any one of the fourth implementation manner to the eighth implementation manner of the first aspect, in a ninth implementation manner, the anti-theft operation includes at least one of the following operations displaying specified information, locking the mobile terminal, deleting or encrypting stored user data, performing a positioning operation, or ringing.

With reference to any one of the first aspect to the ninth implementation manner of the first aspect, in a tenth implementation manner, the database further stores a preset operation corresponding to the correspondence stored in the database, and performing, by the mobile terminal, a corresponding control operation according to a determining result includes performing, by the mobile terminal, the preset operation if the determining result is that the correspondence between the current time period and the network identifier of the network message received in the current time period complies with the correspondence stored in the database, where the preset operation is associated with the correspondence stored in the database.

With reference to any one of the first aspect to the tenth implementation manner of the first aspect, in an eleventh implementation manner, the database stores the correspondence between the time period and the network identifier in a time sequence manner, or the database stores the correspondence between the time period and the network identifier in a network identifier classification manner.

According to a second aspect, an embodiment of the present disclosure provides a mobile terminal, including a receiving module configured to receive at least one network message in a current time period, where the at least one network message is sent by at least one network device, an obtaining module configured to obtain, according to the network message received in the current time period, a network identifier of the network message received in the current time period, a determining module configured to determine whether a correspondence between the current time period and the network identifier of the network message received in the current time period complies with a correspondence stored in a database, where the correspondence stored in the database includes a correspondence between a time period and a network identifier that are of a network message received by the mobile terminal before the current time period, and an execution module configured to perform a corresponding control operation according to a determining result.

With reference to the second aspect, in a first implementation manner, the network device includes a mobile communications base station, and the network identifier includes a Cell ID.

With reference to the second aspect or the first implementation manner, in a second implementation manner, the network device includes a WI-FI access point device, and the network identifier includes an SSID.

With reference to any one of the second aspect to the second implementation manner of the second aspect, in a third implementation manner, the network device includes a BLUETOOTH pairing device, and the network identifier includes BLUETOOTH device identification.

With reference to any one of the second aspect to the third implementation manner of the second aspect, in a fourth implementation manner, the execution module is further configured to determine whether the mobile terminal is in a missing claiming state by querying a network server if the determining result is that the correspondence between the current time period and the network identifier of the network message received in the current time period does not comply with the correspondence stored in the database, and perform an anti-theft operation if the mobile terminal is in the missing claiming state.

With reference to any one of the second aspect or the third implementation manner of the second aspect, in a fifth implementation manner, the execution module is further configured to perform an anti-theft operation if the determining result is that the correspondence between the current time period and the network identifier of the network message received in the current time period does not comply with the correspondence stored in the database.

With reference to any one of the second aspect or the third implementation manner of the second aspect, in a sixth implementation manner, the execution module is further configured to perform identity authentication for a holder of the mobile terminal if the determining result is that the correspondence between the current time period and the network identifier of the network message received in the current time period does not comply with the correspondence stored in the database, and perform an anti-theft operation if authentication fails.

With reference to any one of the second aspect or the third implementation manner of the second aspect, in a seventh implementation manner, the determining module is further configured to determine whether the mobile terminal has a network information receiving capability, and the mobile terminal performs identity authentication for a holder of the mobile terminal if the mobile terminal does not have the network information receiving capability, and performs an anti-theft operation if authentication fails.

With reference to the sixth implementation manner or the seventh implementation manner of the second aspect, in an eighth implementation manner, the identity authentication includes at least one of password authentication, pattern unlocking, or biometric feature recognition.

With reference to any one of the fourth implementation manner to the eighth implementation manner of the second aspect, in a ninth implementation manner, the anti-theft operation includes at least one of the following operations, such as displaying specified information, locking the mobile terminal, deleting or encrypting stored user data, performing a positioning operation, or ringing.

With reference to any one of the second aspect to the ninth implementation manner of the second aspect, in a tenth implementation manner, the database further stores a preset operation corresponding to the correspondence stored in the database, and the execution module is further configured to perform the preset operation if the determining result is that the correspondence between the current time period and the network identifier of the network message received in the current time period complies with the correspondence stored in the database, where the preset operation is associated with the correspondence stored in the database.

With reference to any one of the second aspect to the tenth implementation manner of the second aspect, in an eleventh implementation manner, the database stores the correspondence between the time period and the network identifier in a time sequence manner, or the database stores the correspondence between the time period and the network identifier in a network identifier classification manner.

According to a third aspect, an embodiment of the present disclosure provides a mobile terminal, including a receiver configured to receive at least one network message in a current time period, where the at least one network message is sent by at least one network device, and a processor configured to obtain, according to the network message received in the current time period, a network identifier of the network message received in the current time period, determine whether a correspondence between the current time period and the network identifier of the network message received in the current time period complies with a correspondence stored in a database, where the correspondence stored in the database includes a correspondence between a time period and a network identifier that are of a network message received by the mobile terminal before the current time period, and perform a corresponding control operation according to a determining result.

With reference to the third aspect, in a first implementation manner, the network device includes a mobile communications base station, and the network identifier includes a Cell ID.

With reference to the third aspect or the first implementation manner, in a second implementation manner, the network device includes a WI-FI access point device, and the network identifier includes an SSID.

With reference to any one of the third aspect to the second implementation manner of the third aspect, in a third implementation manner, the network device includes a BLUETOOTH pairing device, and the network identifier includes BLUETOOTH device identification.

With reference to any one of the third aspect to the third implementation manner of the third aspect, in a fourth implementation manner, the processor is further configured to determine whether the mobile terminal is in a missing claiming state by querying a network server if the determining result is that the correspondence between the current time period and the network identifier of the network message received in the current time period does not comply with the correspondence stored in the database, and perform an anti-theft operation if the mobile terminal is in the missing claiming state.

With reference to any one of the third aspect or the third implementation manner of the third aspect, in a fifth implementation manner, the processor is further configured to perform an anti-theft operation if the determining result is that the correspondence between the current time period and the network identifier of the network message received in the current time period does not comply with the correspondence stored in the database.

With reference to any one of the third aspect or the third implementation manner of the third aspect, in a sixth implementation manner, the processor is further configured to perform identity authentication for a holder of the mobile terminal if the determining result is that the correspondence between the current time period and the network identifier of the network message received in the current time period does not comply with the correspondence stored in the database, and perform an anti-theft operation if authentication fails.

With reference to any one of the third aspect or the third implementation manner of the third aspect, in a seventh implementation manner, the processor is further configured to determine whether the mobile terminal has a network information receiving capability, and if the mobile terminal does not have the network information receiving capability, the mobile terminal performs identity authentication for a holder of the mobile terminal, and performs an anti-theft operation if authentication fails.

With reference to the sixth implementation manner or the seventh implementation manner of the third aspect, in an eighth implementation manner, the identity authentication includes at least one of password authentication, pattern unlocking, or biometric feature recognition.

With reference to any one of the fourth implementation manner to the eighth implementation manner of the third aspect, in a ninth implementation manner, the anti-theft operation includes at least one of the following operations, such as displaying specified information, locking the mobile terminal, deleting or encrypting stored user data, performing a positioning operation, or ringing.

With reference to any one of the third aspect to the ninth implementation manner of the third aspect, in a tenth implementation manner, the database further stores a preset operation corresponding to the correspondence stored in the database, and the processor is further configured to perform the preset operation if the determining result is that the correspondence between the current time period and the network identifier of the network message received in the current time period complies with the correspondence stored in the database, where the preset operation is associated with the correspondence stored in the database.

With reference to any one of the third aspect to the tenth implementation manner of the third aspect, in an eleventh implementation manner, the database stores the correspondence between the time period and the network identifier in a time sequence manner, or the database stores the correspondence between the time period and the network identifier in a network identifier classification manner.

According to the mobile terminal control method and the mobile terminal that are provided in the embodiments of the present disclosure, a corresponding control operation may be adaptively performed according to a network message received in real time and a correspondence stored in a database in order to bring convenience to a user.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a schematic flowchart of Embodiment 1 of a mobile terminal control method according to the present disclosure;

FIG. 2A and FIG. 2B are a schematic flowchart of Embodiment 2 of a mobile terminal control method according to the present disclosure;

FIG. 3 is a first schematic diagram of a database according to Embodiment 2 of the present disclosure;

FIG. 4 is a second schematic diagram of a database according to Embodiment 2 of the present disclosure;

FIG. 5A and FIG. 5B are a schematic flowchart of Embodiment 3 of a mobile terminal control method according to the present disclosure;

FIG. 6 is a schematic structural diagram of Embodiment 1 of a mobile terminal according to the present disclosure; and

FIG. 7 is a schematic structural diagram of Embodiment 2 of a mobile terminal according to the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

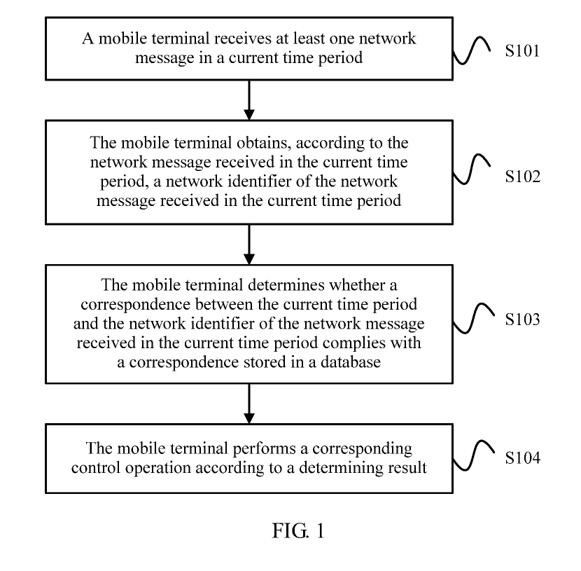

FIG. 1 is a schematic flowchart of Embodiment 1 of a mobile terminal control method according to the present disclosure. As shown in FIG. 1, this embodiment is executed by a common mobile terminal, such as a smartphone or an iPad. Further, this embodiment includes the following steps.

Step S101: The mobile terminal receives at least one network message in a current time period.

The at least one network message is sent by at least one network device. The at least one network device includes at least one or a combination of the following devices, such as a mobile communications base station (referred to as a base station in the following), a WI-FI access device, or a BLUETOOTH pairing device.

The current time period may be a time period with specific duration, for example, a time period from 9:00 to 10:00. In the current time period, the mobile terminal moves from a position A to a position B, and during the movement, the mobile terminal receives a network message sent by a mobile communications base station (one or more) that covers the position A and a network message sent by a mobile communications base station (one or more) that covers the position B. In addition, when a WI-FI access device or a BLUETOOTH pairing device that may be paired with the mobile terminal exists near the position A and the position B, the mobile terminal further receives a network message sent by the WI-FI access device or the BLUETOOTH pairing device.

Optionally, the current time period may be divided into a time point. For example, the mobile terminal receives a network message sent by a mobile communications base station (one or more) that covers a cell B at a time point 10:10. The mobile terminal may further receive a network message sent by a WI-FI access device, a BLUETOOTH pairing device, or the like that is disposed in the cell B.

Step S102: The mobile terminal obtains, according to the network message received in the current time period, a network identifier of the network message received in the current time period.

A network message carries a network identifier. After receiving the network message, the mobile terminal may obtain the network identifier of the network message. Further, if the network device that sends the network message is a mobile communications base station, the network identifier includes a Cell ID. If the network device that sends the network message is a WI-FI access point device, the network identifier includes an SSID. If the network device that sends the network message is a BLUETOOTH pairing device, the network identifier includes BLUETOOTH device identification.

Step S103: The mobile terminal determines whether a correspondence between the current time period and the network identifier of the network message received in the current time period complies with a correspondence stored in a database.

The correspondence stored in the database includes a correspondence between a time period and a network identifier that are of a network message received by the mobile terminal before the current time period.

It should be noted that the current time period and the time period before the current time period are not objective time. For example, 9:00 on a current day is different from 9:00 on a previous day in terms of objective time. However, when storing a correspondence between a network identifier and a time period, the database stores a correspondence between a network identifier and a time period to which 9:00 belongs. For example, the current time period is 10:00 to 10:10 on the current day, and the time period before the current time period is any one of time periods before 10:00 on the current day. 9:00 and 10:00 on the previous day are used as an example. The mobile terminal is located in a coverage area of a base station 3 and a coverage area of a base station 4 at 9:00 and 10:00 on the previous day respectively, and the mobile terminal receives a network message sent by the base station 3 and a network message sent by the base station 4 at 9:00 and 10:00 on the previous day respectively. A network identifier of the network message sent by the base station 3 is Cell-ID-3, and a network identifier of the network message sent by the base station 4 is Cell-ID-4. Therefore, the correspondence established in the database includes a correspondence between Cell-ID-3 and 9:00, and a correspondence between Cell-ID-4 and 10:00. In addition, the correspondences may reflect a behavior mode of a user of the mobile terminal. Generally, human behavior habits follow a rule. A behavior mode of the user of the mobile terminal may be extracted according to a time period and a network identifier of network information received within a specific time. For example, a behavior mode reflected by the correspondences is that the user carrying the mobile terminal is located in the coverage area of the base station 3 at 9:00 each day, and in the coverage area of the base station 4 at 10:00 each day. Therefore, when a network identifier whose network identifier is Cell-ID-4 is received at 10:00 on the current day, because the database stores the correspondence between Cell-ID-4 and 10:00, the mobile terminal may determine that Cell-ID-4 and 10:00 on the current day comply with the correspondence between Cell-ID-4 and 10:00 that is stored in the database. Alternatively, when a network message whose network identifier is Cell-ID-5 is received at 10:00 on the current day, because the correspondence stored in the database is Cell-ID-4 corresponding to 10:00, 10:00 on the current day and Cell-ID-5 do not comply with the correspondence in the database.

In addition, “current” in the current time period is a relative concept. That is, when objective time is 10:00 on the current day, 10:00 on the current day is a current time period. However, as the objective time goes by and becomes 11:00 on the current day, 11:00 on the current day is a new current time period.

Step S104: The mobile terminal performs a corresponding control operation according to a determining result.

When the mobile terminal determines, by performing step S103, that the correspondence between the current time period and the network identifier of the network message complies with the correspondence stored in the database, it indicates that the mobile terminal is in a normal scenario, or it may indicate that behavior of a holder of the mobile terminal in the current time period complies with a user behavior mode reflected by the correspondence in the database. In this case, the corresponding control operation may be further to remain in a standby state, or may be to perform a corresponding control operation. For example, before the current time period, each time the user enters the coverage area of the base station 3 at 9:00, the user sets the mobile terminal to a vibration mode, and an operation of setting the vibration mode is considered as a control operation corresponding to the correspondence between Cell-ID-3 and 9:00 by the mobile terminal. Therefore, when the current time period is 9:00, after a network message sent by the base station 3 is received, and it is determined that a network identifier Cell-ID-3 of the network message and current 9:00 comply with the correspondence between Cell-ID-3 and 9:00 that is stored in the database, the operation of setting the vibration mode may be performed.

Alternatively, when the mobile terminal determines, by performing step S103, that the correspondence between the current time period and the network identifier of the network message does not comply with the correspondence stored in the database, it indicates that the mobile terminal is in an abnormal scenario, that is, behavior of a holder of a mobile phone in the current time period does not comply with a user behavior mode reflected by the correspondence in the database, and the mobile terminal may be stolen. In this case, the holder of the mobile terminal is an unauthorized holder, and a control operation that needs to be adaptively performed is an anti-theft operation. Consequently, the user can conveniently find the lost mobile terminal, or private data in the mobile terminal cannot be stolen, and security and convenience are brought to a life of the user.

In this embodiment, a mobile terminal may adaptively perform a corresponding control operation according to a network message received in real time and a correspondence stored in a database in order to bring convenience to a user. For example, in an office environment, the user does not need the mobile terminal to ring, and the mobile terminal may be adaptively set to a vibration mode provided that a network message sent by a network device in the office environment is received in a current time period. An extra auxiliary tool such as a camera does not need to be used to determine whether the mobile terminal is in the office environment, and power consumption for enabling the extra auxiliary tool may be saved.

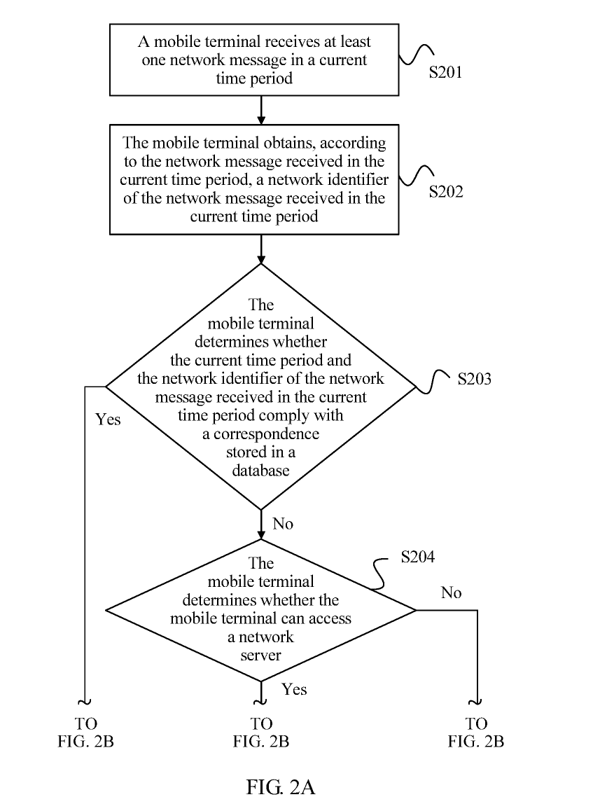

FIG. 2A and FIG. 2B are a schematic flowchart of Embodiment 2 of a mobile terminal control method according to the present disclosure. As shown in FIG. 2A and FIG. 2B, this embodiment gives further description based on the embodiment shown in FIG. 1. Further, this embodiment includes the following steps.

Step S201: The mobile terminal receives at least one network message in a current time period.

Step S202: The mobile terminal obtains, according to the network message received in the current time period, a network identifier of the network message received in the current time period.

Step S203: The mobile terminal determines whether the current time period and the network identifier of the network message received in the current time period comply with a correspondence stored in a database. If the current time period and the network identifier of the network message received in the current time period do not comply with the correspondence stored in the database, perform step S204. If the current time period and the network identifier of the network message received in the current time period comply with the correspondence stored in the database, perform step S208.

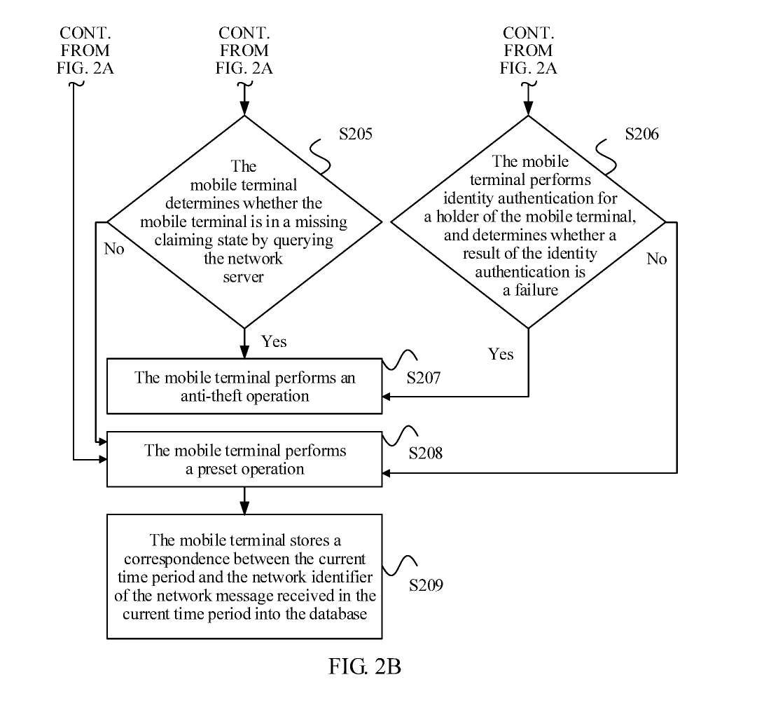

With reference to step S103, a correspondence may be extracted according to a time period and a network identifier that are of a network message received by the mobile terminal before the current time period. The correspondence may reflect a behavior mode of a user of the mobile terminal, and there may be at least one correspondence. Further, FIG. 3 is a first schematic diagram of the database according to Embodiment 2 of the present disclosure. As shown in FIG. 3, the mobile terminal receives multiple network messages before the current time period. A network identifier of a network message is further a Cell-ID, and a time period in which each network message is received is further a time point. For the received multiple network messages, the mobile terminal analyzes, using a method such as pattern recognition, or machine learning, the time period in which each network message is received and a network identifier of each network message. For example, a network identifier of a network message received in a time period t each day is Cell-ID-x, a network identifier of network information received in a time period t+1 is Cell-ID-y, a network identifier of network information received in a time period t+2 is Cell-ID-z, a network identifier of network information received in a time period t+3 is Cell-ID-k, and by analog, a Cell-ID corresponding to each time period may be determined, that is, multiple correspondences are obtained. In addition, the database of the mobile terminal stores a correspondence between a time period and a network identifier in a time sequence manner. For example, the time period t is before the time period t+1, and therefore, a correspondence between the time period t and Cell-ID-x is arranged before a correspondence between the time period t+1 and Cell-ID-y according to a time sequence.

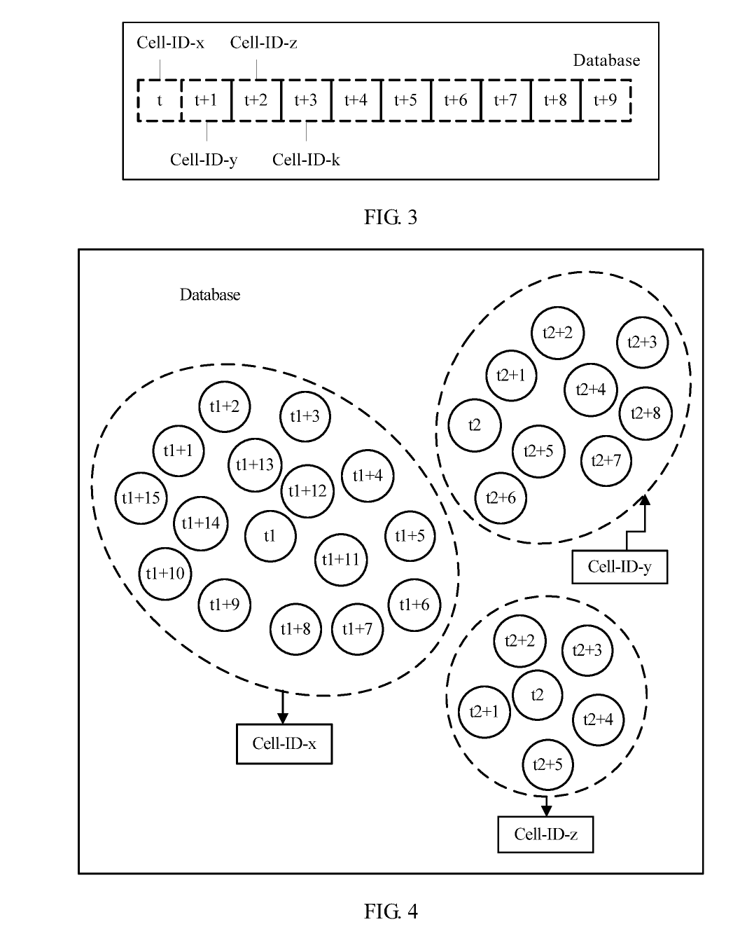

Alternatively, FIG. 4 is a second schematic diagram of the database according to Embodiment 2 of the present disclosure. As shown in FIG. 4, for the multiple network messages received before the current time period, the mobile terminal analyzes, using a method such as pattern recognition, or machine learning, a time point at which each network message is received and a network identifier of each network message. For example, a network message whose network identifier is Cell-ID-x is received in any one of time periods from t1 to t1+15, and a network message whose network identifier is Cell-ID-y is received in any one of time periods from t2 to t2+5. Therefore, Cell-ID-x corresponds to each time period in t1 to t1+15, and Cell-ID-z corresponds to each time period in t2 to t2+5. In addition, when storing these correspondences, the database stores a correspondence between a time period and a network identifier in a network identifier classification manner. That is, Cell-ID-x is used as a category, and information included in the Cell-ID-x category is t1 to t1+15. Information included in a Cell-ID-z category is t2 to t2+5.

Further, when step S203 is performed, the current time period may be a time point, for example, 10:10, and a network message whose network identifier is Cell-ID-x is received at 10:10. Therefore, the correspondence between the current time period and the network identifier of the network message received in the current time period is a correspondence between Cell-ID-x and 10:10. In the database shown in FIG. 3, if there is Cell-ID-x, and the time period t corresponding to Cell-ID-x is further a time period to which 10:10 belongs, or in the database shown in FIG. 4, there is a Cell-ID-x category, and a time period to which 10:10 belongs is in all time periods in the Cell-ID-x category, it indicates that the correspondence between the current time period and the network identifier of the network message received in the current time period complies with the correspondence stored in the database. However, if there is no Cell-ID-x in the database or 10:10 in the time period corresponding to Cell-ID-x, it indicates that the correspondence between the current time period and the network identifier of the network message received in the current time period does not comply with the correspondence stored in the database.

In addition, the time period may be further a time period with specific duration, for example, t indicates a time period from 10:00 to 10:10. Alternatively, the time period may be a time point, that is, t indicates 10:10.

Optionally, when step S203 is performed, the current time period may be a time period with specific duration, for example, from 10:10 to 10:20, and at least one network message is received in the current time period. When S203 is performed, further, the current time period is divided into multiple precise time periods, and it is determined whether a correspondence between a network identifier of a network message received in each precise time periods and the precise time period complies with multiple correspondences stored in the database. For example, in the time period from 10:10 to 10:20, a network message whose network identifier is Cell-ID-x is received at 10:10, a network message whose network identifier is Cell-ID-y is received at 10:15, and a network message whose network identifier is Cell-ID-z is received at 10:20. Therefore, when step S203 is performed, it needs to be determined whether correspondences between the network messages whose network identifiers are Cell-ID-x, Cell-ID-y, and Cell-ID-z and all precise time periods (further including a precise time period to which 10:10 belongs, a precise time period to which 10:15 belongs, and a precise time period to which 10:20 belongs) comply with the correspondence between Cell-ID-x and the time period t, the correspondence between Cell-ID-y and the time period t+1, and the correspondence between Cell-ID-z and the time period t+2 that are in the database.

It may be understood that the user behavior mode can change. The user of the mobile terminal may temporarily leave for another place with the mobile terminal. For example, the user should enter a coverage area of a base station y at 10:15 in order to receive a network message that is sent by the base station y and whose network identifier is Cell-ID-y. However, on one day, the user temporarily enters a coverage area of a base station s at 10:15, and a network message whose network identifier is Cell-ID-s is received. Flexibly, a specific error tolerance rate is allowed when the mobile terminal determines, by performing step S203, whether the correspondence between the current time period and the network identifier of the network message received in the current time period complies with the correspondence stored in the database. For example, a network message whose network identifier is Cell-ID-x is received at 10:10, a network message whose network identifier is Cell-ID-s is received at 10:15, and a network message whose network identifier is Cell-ID-z is received at 10:20. However, in the correspondences stored in the database, the time period t corresponding to Cell-ID-x a time period to which 10:10 belongs, and the time period t+1 is a time period to which 10:15 belongs and corresponds to Cell-ID-y. In this case, in the current time period, a correspondence between a precise time period to which 10:15 belongs and Cell-ID-s does not comply with the correspondence between the time period to which 10:15 belongs and Cell-ID-y that is in the database. However, in the current time period, because both a correspondence between Cell-ID-x and a precise time period to which 10:10 belongs and a correspondence between Cell-ID-z and a precise time period to which 10:20 belongs comply with the correspondences stored in the database, and only the correspondence between the precise time period to which 10:15 belongs and Cell-ID-s does not comply with the correspondence stored in the database, based on a specific error tolerance rate, it may be considered that the correspondence between the current time period and the network identifier of the network message received in the current time period complies with the correspondence stored in the database.

Step S204: The mobile terminal determines whether the mobile terminal can access a network server. If the mobile terminal can access the network server, perform step S205. If the mobile terminal cannot access the network server, perform step S206.

It should be noted that in step S203, when the correspondence between the current time period and the network identifier of the network message received in the current time period does not comply with the correspondence stored in the database, it indicates that behavior of a holder of the mobile terminal does not comply with the behavior mode of the user of the mobile terminal, the mobile terminal may be stolen, and step S207 may be immediately performed. That is, the mobile terminal immediately performs an anti-theft operation provided that a determining result in step S203 is that the correspondence between the current time period and the network identifier of the network message received in the current time period does not comply with the correspondence stored in the database. However, to improve accuracy of determining whether the mobile terminal is stolen, and avoid triggering the anti-theft operation when it is determined by mistake that the mobile terminal is stolen, after the mobile terminal preliminarily determines that the mobile terminal may be stolen, final confirmation needs to be performed, that is, steps S204 to S206 need to be further performed.

There may be two types of methods for performing final confirmation, performing final confirmation by querying a network server online, and performing final confirmation in the mobile terminal locally. Therefore, before final confirmation is performed, whether the mobile terminal can access the network server needs to be determined. That is, whether the mobile terminal can access a network (further, a cellular network, a WI-FI network, or the like) is determined in step S204.

Step S205. The mobile terminal queries the network server, and determines whether the mobile terminal is in a missing claiming state. If the mobile terminal is in the missing claiming state, perform step S207. If the mobile terminal is not in the missing claiming state, perform step S208.

Further, the user registers the mobile terminal with a network server provided by a brand owner of the mobile terminal, or the user registers, using an application on the mobile terminal, the mobile terminal with a network server of the application, or registers the mobile terminal with a server of an operator. The user may access these network servers using another terminal device, and claim missing of the mobile terminal in order to find the lost mobile terminal online when the mobile terminal is stolen. After the user claims missing, the network server records that the mobile terminal is in the missing claiming state. The mobile terminal itself determines whether the mobile terminal is in the missing claiming state by performing steps S201 to S205 when the user searches for the lost mobile terminal.

Step S206: The mobile terminal performs identity authentication for a holder of the mobile terminal, and determines whether a result of the identity authentication is a failure. If the result of the identity authentication is a failure, perform step S207. If the result of the identity authentication is not a failure, perform step S208.

An operation of the identity authentication includes at least one of the following operations, password authentication, pattern unlocking, biometric recognition, or the like. The biometric recognition may be fingerprint recognition, face recognition, voiceprint recognition, or the like.

Step S207: The mobile terminal performs an anti-theft operation.

The anti-theft operation includes at least one of the following operations.

The mobile terminal displays specified information, the mobile terminal locks the mobile terminal, the mobile terminal deletes or encrypts stored user data, the mobile terminal rings for alerting, the mobile terminal enables a camera to take a photo, and sends the photo the network server, or the mobile terminal performs a positioning operation, and sends positioning information to the network server.

Further, the specified information may be set by the user, for example, “please call 135xxxxxxxx if you pick up this mobile phone.” After the mobile terminal is locked, the mobile terminal cannot be normally used. To prevent disclosure of private information of the user due to a loss of the mobile terminal, the mobile terminal itself may delete the user data stored in the mobile terminal, or may encrypt the stored user data. More preferably, to help the user find the mobile terminal as soon as possible, the mobile terminal may perform the positioning operation, and send the positioning information obtained by performing the positioning operation to the network server. In addition, the mobile terminal may enable the camera to take a photo of an unauthorized holder of the mobile terminal.

Step S208: The mobile terminal performs a preset operation.

The preset operation is associated with the correspondence stored in the database.

Further, when the correspondence between the current time period and the network identifier of the network message received in the current time period complies with the correspondence stored in the database, it indicates that the mobile terminal is in a normal scenario, or it may indicate that behavior of a holder of the mobile terminal in the current time period complies with a user behavior mode reflected by the correspondence in the database. In this case, the corresponding control operation may be to remain in a standby state, or may be to perform a corresponding control operation. For example, before the current time period, each time the user enters a coverage area of a base station 3 at 9:00, the user receives a network message whose network identifier is Cell-ID-3, and sets the mobile terminal to a vibration mode. The mobile terminal uses an operation of setting the vibration mode as a preset operation, makes a record, and associates the preset operation with a correspondence between Cell-ID-3 and 9:00. Therefore, in the current time period, that is, 9:00 on a current day, after a network message sent by the base station 3 is received, and it is determined that a network identifier Cell-ID-3 of the network message and current 9:00 comply with the correspondence between Cell-ID-3 and 9:00 that is stored in the database, the operation of setting the vibration mode may be performed.

Optionally, the preset operation may be an operation such as connecting the mobile terminal to a WI-FI access point, or notifying the user of arriving at a station.

It should be noted that if it is determined by performing step S203 that the current time period and the network identifier of the network message received in the current time period do not comply with the correspondence stored in the database, step S208 is immediately performed. If it is determined, by performing step S205, that the mobile terminal is not in the missing claiming state, or it is determined, by performing step S206, that authentication of the holder of the mobile terminal succeeds, step S208 may not be performed. Further, when the user travels on business with the mobile terminal, an identifier of a network message received in the time period t+3 is Cell-ID-p instead of Cell-ID-k. In this case, even if it is determined, by performing steps S204 or S205, that the mobile terminal is not stolen, a correspondence between Cell-ID-p and t+3 is not in the database, and there is no preset operation, or in other words, the preset operation in this case is to remain in a standby state.

Optionally, to update the correspondence in the database in a timely manner, and ensure accuracy of determining by the mobile terminal, step S209 may be further performed after step S208 is performed or after it is determined that the mobile terminal is not stolen in step S204 or step S205.

Step S209: The mobile terminal stores the correspondence between the current time period and the network identifier of the network message received in the current time period into the database.

If the network message received in the current time period is a network message received by the mobile terminal for the first time, the correspondence between the current time period and the network identifier of the network message received in the current time period is stored into the database, that is, a database is established. As time goes by, each time a network message is received in a new current time period and it is determined that the mobile terminal is not stolen, the database is updated according to a network identifier of the network message received in the new current time period and the new current time period. As increasingly more correspondences are stored in the database, the mobile terminal more accurately determines whether the mobile terminal is stolen, and convenience is brought to the user.

However, when the correspondence between the network identifier of the network message received in the current time period and the current time period does not comply with the correspondence stored in the database, and it is determined, by querying the network server or after performing identity authentication for the holder of the mobile terminal, that the mobile terminal is stolen, the network message received in the current time period is discarded. That is, the database is not updated according to the network identifier of the network message received in the current time period and the current time period.

It should be additionally noted that when the database is continuously updated, obsolete information needs to be further removed. For example, a correspondence is determined according to a network message received in a first time point (an objective time point, for example, 9:00 in 30 previous days) before the current time period and the first time point. A difference between the first time point and an objective time point (that is, 9:00 on a current day) corresponding to the current time period is greater than α (a preset value), for example, α is 30 days. Therefore, the correspondence is determined as obsolete information, and the mobile terminal deletes the obsolete information.

In this embodiment, a mobile terminal may adaptively perform a corresponding control operation according to a network message received in real time and a correspondence stored in a database in order to bring convenience to a user. For example, in an office environment, the user does not need the mobile terminal to ring, and the mobile terminal may be adaptively set to a vibration mode provided that a network message sent by a network device in the office environment is received in a current time period. An extra auxiliary tool such as a camera does not need to be used to determine whether the mobile terminal is in the office environment, and power consumption for enabling the extra auxiliary tool may be saved. In addition, before the mobile terminal finally determines that the mobile terminal is stolen, whether the mobile terminal is stolen is determined by querying a network server or using an identity authentication operation of the mobile terminal itself, thereby improving accuracy of performing the corresponding control operation by the mobile terminal.

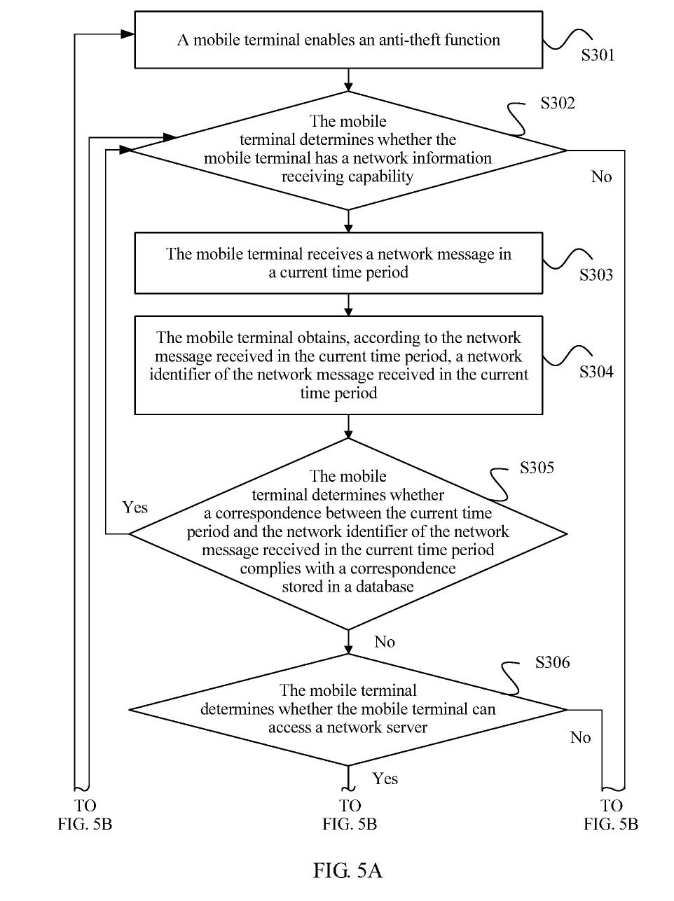

FIG. 5A and FIG. 5B are a schematic flowchart of Embodiment 3 of a mobile terminal control method according to the present disclosure. As shown in FIG. 5A and FIG. 5B, based on the embodiment shown in FIG. 1 or FIG. 2A and FIG. 2B, performing an anti-theft operation is used as a service function of the mobile terminal, and more detailed description is provided in this embodiment. Further, this embodiment includes the following steps.

Step S301: The mobile terminal enables an anti-theft function.

After enabling the anti-theft function, the mobile terminal may perform steps S302 to S311 in real time, and may immediately perform an anti-theft operation after finding, in a timely manner, that the mobile terminal is stolen. To prevent an unauthorized person from disabling the anti-theft function in the mobile terminal in a manner such as a factory reset manner, code for implementing the anti-theft function is written to an operating system of the mobile terminal or programmed into a read-only memory (ROM) of the mobile terminal.

Step S302: The mobile terminal determines whether the mobile terminal has a network information receiving capability. If the mobile terminal has the network information receiving capability, perform step S303. If the mobile terminal does not have the network information receiving capability, perform step S309.

A common smartphone is used as an example. Whether the mobile terminal has a network information receiving capability may be determined by determining whether the mobile phone is in an airplane mode. When the mobile phone is in an airplane mode, the mobile phone may obtain a determining result from system data. For example, in an ANDROID operating system, whether the mobile phone is in an airplane mode may be determined using the following function (in a JAVA language): boolean isEnabled=Settings.System.getInt(getContentResolver( ),Settings.System.AIRPLANE_MODE_ON,0)==1.

When a result of the function is True, it indicates that the mobile phone is in the airplane mode, and the mobile phone waits to receive network information, that is, perform step S309. When the result is False, it indicates that the mobile phone is not in the airplane mode, and the mobile phone waits to perform step S303.

Step S303: The mobile terminal receives a network message in a current time period.

Step S304: The mobile terminal obtains, according to the network message received in the current time period, a network identifier of the network message received in the current time period.

Step S305: The mobile terminal determines whether a correspondence between the current time period and the network identifier of the network message received in the current time period complies with a correspondence stored in a database. If the correspondence between the current time period and the network identifier of the network message received in the current time period does not comply with the correspondence stored in the database, perform step S306. If the correspondence between the current time period and the network identifier of the network message received in the current time period complies with the correspondence stored in the database, go back to step S302 (or wait to perform step S303 without performing step S302).

For example, the network message is base station information sent by a base station. When the base station information is received, in an ANDROID operating system, a network identifier in the base station information may be obtained using a function (in a JAVA language) NetworkInfo getNetworkInfo(int networkType), and networkType=TYPE_MOBILE is input.

Step S306: The mobile terminal determines whether the mobile terminal can access a network server. If the mobile terminal can access the network server, perform step S307. If the mobile terminal cannot access the network server, perform step S309.

Step S307: The mobile terminal determines whether the mobile terminal is in a missing claiming state by querying the network server. If the mobile terminal is in the missing claiming state, perform step S308. If the mobile terminal is not in the missing claiming state, perform step S302 (or wait to perform step S303 without performing step S302).

Step S308: The mobile terminal performs an anti-theft operation.

Step S309: The mobile terminal performs identity authentication for a holder of the mobile terminal, and determines whether a result of the identity authentication is a failure. If the result of the identity authentication is a failure, perform step S308. If the result of the identity authentication is not a failure, perform step S310.

Step S310: The mobile terminal disables the anti-theft function.

After it is determined, by performing step S309, that the holder of the mobile terminal is still an authorized user of the mobile terminal, it may be figured out that the mobile terminal is still possessed by the authorized user in a near future. To avoid interference to the user due to frequent identity authentication for the user, the anti-theft function may be disabled in the near future.

Step S311: The mobile terminal obtains a trigger condition for enabling the anti-theft function, go back to step S301.

After the mobile terminal disables the anti-theft function, the mobile terminal performs monitoring. When the mobile terminal obtains the trigger condition for enabling the anti-theft function, immediately go back to step S301, and perform anti-theft protection for the mobile terminal. The trigger condition for enabling the anti-theft function may be preset by the user using the mobile terminal. For example, the trigger condition is preset duration. That is, after the mobile terminal performs step S310, the mobile terminal starts a timer, and when the mobile terminal determines that the timer with the preset duration expires, the mobile terminal obtains the trigger condition for enabling the anti-theft function.

It should be additionally noted that, in this embodiment, in a process of going back to step S302 (or waiting to perform step S303) after performing step S305, the mobile terminal considers that the mobile terminal is not stolen, and the mobile terminal may further perform step S208 and/or step S209 in the foregoing embodiment. Similarly, in a process of going back to step S302 (or waiting to perform step S303) after performing step S307, the mobile terminal may further perform step S209 in the foregoing embodiment. In addition, when performing steps S308 to S310, the mobile terminal may further perform step S209 in the foregoing embodiment.

In this embodiment, a mobile terminal determines a usage scenario of the mobile terminal in a current time point according to network information received in real time and obtained historical network information, and further determines, by querying a network server or using an identity authentication operation of the mobile terminal itself, whether the mobile terminal is in an abnormal scenario before the mobile terminal finally determines that the usage scenario is the abnormal scenario. Therefore, the usage scenario is more accurately determined, and use security of the mobile terminal of a user is effectively ensured.

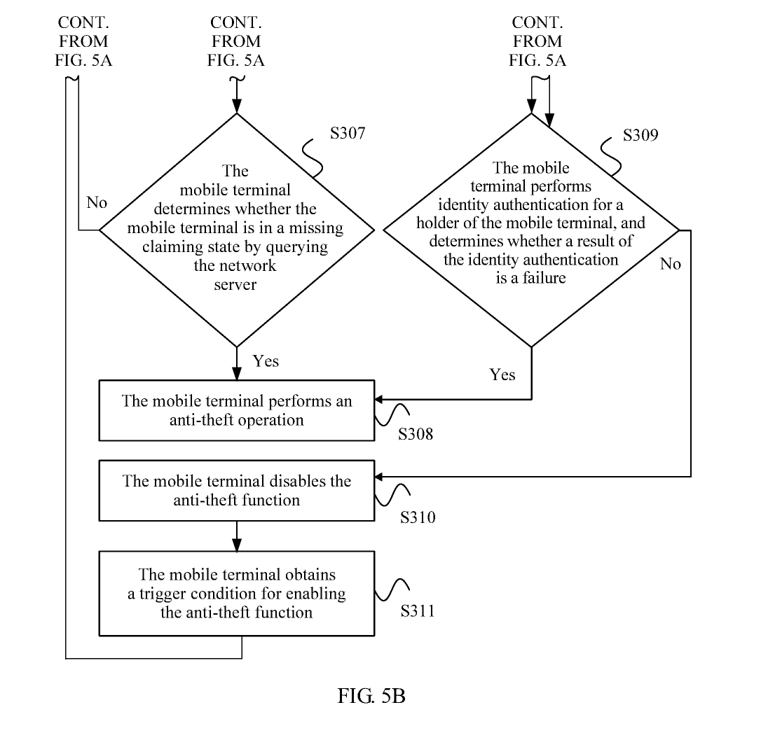

FIG. 6 is a schematic structural diagram of Embodiment 1 of a mobile terminal according to the present disclosure. As shown in FIG. 6, the mobile terminal includes a receiving module 11 configured to receive at least one network message in a current time period, where the at least one network message is sent by at least one network device, an obtaining module 12 configured to obtain, according to the network message received in the current time period, a network identifier of the network message received in the current time period, a determining module 13 configured to determine whether a correspondence between the current time period and the network identifier of the network message received in the current time period complies with a correspondence stored in a database, where the correspondence stored in the database includes a correspondence between a time period and a network identifier that are of a network message received by the mobile terminal before the current time period, and an execution module 14 configured to perform a corresponding control operation according to a determining result.

Optionally, the network device includes a mobile communications base station, and the network identifier includes a Cell ID.

Optionally, the network device includes a WI-FI access point device, and the network identifier includes an SSID.

Optionally, the network device includes a BLUETOOTH pairing device, and the network identifier includes BLUETOOTH device identification.

The execution module 14 is further configured to determine whether the mobile terminal is in a missing claiming state by querying a network server if the determining result is that the correspondence between the current time period and the network identifier of the network message received in the current time period does not comply with the correspondence stored in the database, and perform an anti-theft operation if the mobile terminal is in the missing claiming state.

The execution module 14 is further configured to perform an anti-theft operation if the determining result is that the correspondence between the current time period and the network identifier of the network message received in the current time period does not comply with the correspondence stored in the database.

The execution module 14 is further configured to perform identity authentication for a holder of the mobile terminal if the determining result is that the correspondence between the current time period and the network identifier of the network message received in the current time period does not comply with the correspondence stored in the database, and perform an anti-theft operation if authentication fails.

The determining module 13 is further configured to determine whether the mobile terminal has a network information receiving capability, and if the mobile terminal does not have the network information receiving capability, the mobile terminal performs identity authentication for a holder of the mobile terminal, and performs an anti-theft operation if authentication fails.

Further, the identity authentication includes at least one of password authentication, pattern unlocking, or biometric feature recognition.

Further, the anti-theft operation includes at least one of the following operations, such as displaying specified information, locking the mobile terminal, deleting or encrypting stored user data, performing a positioning operation, or ringing.

Further, the database further stores a preset operation corresponding to the correspondence stored in the database, and the execution module 14 is further configured to perform the preset operation if the determining result is that the correspondence between the current time period and the network identifier of the network message received in the current time period complies with the correspondence stored in the database. The preset operation is associated with the correspondence stored in the database.

Further, the database stores the correspondence between the time period and the network identifier in a time sequence manner, or the database stores the correspondence between the time period and the network identifier in a network identifier classification manner.

In this embodiment, a mobile terminal may adaptively perform a corresponding control operation according to a network message received in real time and a correspondence stored in a database in order to bring convenience to a user. For example, in an office environment, the user does not need the mobile terminal to ring, and the mobile terminal may be adaptively set to a vibration mode provided that a network message sent by a network device in the office environment is received in a current time period. An extra auxiliary tool such as a camera does not need to be used to determine whether the mobile terminal is in the office environment, and power consumption for enabling the extra auxiliary tool may be saved.

It should be noted that the modules correspondingly perform steps in the foregoing method embodiments. For a specific execution process and a technical effect, refer to the steps in the foregoing method embodiments.

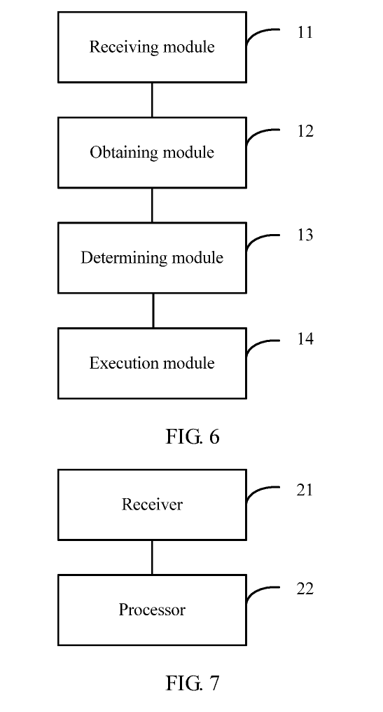

FIG. 7 is a schematic structural diagram of Embodiment 2 of a mobile terminal according to the present disclosure. As shown in FIG. 7, the mobile terminal includes a receiver 21 configured to receive at least one network message in a current time period, where the at least one network message is sent by at least one network device, and a processor 22 configured to obtain, according to the network message received in the current time period, a network identifier of the network message received in the current time period, determine whether a correspondence between the current time period and the network identifier of the network message received in the current time period complies with a correspondence stored in a database, where the correspondence stored in the database includes a correspondence between a time period and a network identifier that are of a network message received by the mobile terminal before the current time period, and perform a corresponding control operation according to a determining result.

Optionally, the network device includes a mobile communications base station, and the network identifier includes a Cell ID.

Optionally, the network device includes a WI-FI access point device, and the network identifier includes an SSID.

Optionally, the network device includes a BLUETOOTH pairing device, and the network identifier includes BLUETOOTH device identification.

The processor 22 is further configured to determine whether the mobile terminal is in a missing claiming state by querying a network server if the determining result is that the correspondence between the current time period and the network identifier of the network message received in the current time period does not comply with the correspondence stored in the database, and perform an anti-theft operation if the mobile terminal is in the missing claiming state.

The processor 22 is further configured to perform an anti-theft operation if the determining result is that the correspondence between the current time period and the network identifier of the network message received in the current time period does not comply with the correspondence stored in the database.

The processor is further configured to perform identity authentication for a holder of the mobile terminal if the determining result is that the correspondence between the current time period and the network identifier of the network message received in the current time period does not comply with the correspondence stored in the database, and perform an anti-theft operation if authentication fails.

The processor 22 is further configured to determine whether the mobile terminal has a network information receiving capability, and the mobile terminal performs identity authentication for a holder of the mobile terminal if the mobile terminal does not have the network information receiving capability, and performs an anti-theft operation if authentication fails.

Further, the identity authentication includes at least one of password authentication, pattern unlocking, or biometric feature recognition.

Further, the anti-theft operation includes at least one of the following operations, such as displaying specified information, locking the mobile terminal, deleting or encrypting stored user data, performing a positioning operation, or ringing.

Further, the database further stores a preset operation corresponding to the correspondence stored in the database, and the processor 22 is further configured to perform the preset operation if the determining result is that the correspondence between the current time period and the network identifier of the network message received in the current time period complies with the correspondence stored in the database. The preset operation is associated with the correspondence stored in the database.

Further, the database stores the correspondence between the time period and the network identifier in a time sequence manner, or the database stores the correspondence between the time period and the network identifier in a network identifier classification manner.

In this embodiment, a mobile terminal may adaptively perform a corresponding control operation according to a network message received in real time and a correspondence stored in a database in order to bring convenience to a user. For example, in an office environment, the user does not need the mobile terminal to ring, and the mobile terminal may be adaptively set to a vibration mode provided that a network message sent by a network device in the office environment is received in a current time period. An extra auxiliary tool such as a camera does not need to be used to determine whether the mobile terminal is in the office environment, and power consumption for enabling the extra auxiliary tool may be saved.

It should be noted that the receiver and processor correspondingly perform steps in the foregoing method embodiments. For a specific execution process and a technical effect, refer to the steps in the foregoing method embodiments.

Persons of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes any medium that can store program code, such as a ROM, a random access memory (RAM), a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A mobile terminal control method, comprising:
receiving, by a mobile terminal, at least one network message in a current time period, wherein the at least one network message is sent by at least one network device;
obtaining, by the mobile terminal according to the at least one network message received in the current time period, a network identifier of the at least one network message received in the current time period;
determining, by the mobile terminal, whether a correspondence between the current time period and the network identifier of the at least one network message received in the current time period complies with a correspondence stored in a database, wherein the correspondence stored in the database comprises a correspondence between a time period and a network identifier of a network message received by the mobile terminal before the current time period; and
performing, by the mobile terminal, a corresponding control operation according to a determining result.

2. The control method according to claim 1, wherein the at least one network device comprises a mobile communications base station, and wherein the network identifier comprises a cell identity (Cell ID).

3. The control method according to claim 1, wherein the at least one network device comprises a WI-FI access point device, and wherein the network identifier comprises a service set identifier (SSID).

4. The control method according to claim 1, wherein the at least one network device comprises a BLUETOOTH pairing device, and wherein the network identifier comprises BLUETOOTH device identification.

5. The control method according to claim 1, wherein performing the corresponding control operation comprises:
determining, by the mobile terminal, whether the mobile terminal is in a missing claiming state by querying a network server when the correspondence between the current time period and the network identifier of the at least one network message received in the current time period does not comply with the correspondence stored in the database; and
performing, by the mobile terminal, an anti-theft operation when the mobile terminal is in the missing claiming state.

6. The control method according to claim 1, wherein performing the corresponding control operation comprises performing, by the mobile terminal, an anti-theft operation when the correspondence between the current time period and the network identifier of the at least one network message received in the current time period does not comply with the correspondence stored in the database.

7. The control method according to claim 1, wherein performing the corresponding control operation comprises:
performing, by the mobile terminal, identity authentication for a holder of the mobile terminal when the correspondence between the current time period and the network identifier of the at least one network message received in the current time period does not comply with the correspondence stored in the database; and
performing, by the mobile terminal, an anti-theft operation when the identity authentication fails.

8.-9. (canceled)

10. The control method according to claim 5, wherein the anti-theft operation comprises at least one of: displaying specified information, locking the mobile terminal, deleting or encrypting stored user data, performing a positioning operation, or ringing.

11. The control method according to claim 1, wherein the database further stores a preset operation corresponding to the correspondence stored in the database, and wherein performing the corresponding control operation comprises performing, by the mobile terminal, the preset operation when the correspondence between the current time period and the network identifier of the at least one network message received in the current time period complies with the correspondence stored in the database, and wherein the preset operation is associated with the correspondence stored in the database.

12. The control method according to claim 1, wherein the database stores the correspondence between the time period and the network identifier in a time sequence manner or in a network identifier classification manner.

13.-24. (canceled)

25. A mobile terminal, comprising:
a receiver configured to receive at least one network message in a current time period, wherein the at least one network message is sent by at least one network device; and
a processor configured to:
obtain, according to the at least one network message received in the current time period, a network identifier of the at least one network message received in the current time period;
determine whether a correspondence between the current time period and the network identifier of the at least one network message received in the current time period complies with a correspondence stored in a database, wherein the correspondence stored in the database comprises a correspondence between a time period and a network identifier of a network message received by the mobile terminal before the current time period; and
perform a corresponding control operation according to a determining result.

26. The mobile terminal according to claim 25, wherein the at least one network device comprises a mobile communications base station, and wherein the network identifier comprises a cell identity (Cell ID).

27. The mobile terminal according to claim 25, wherein the at least one network device comprises a WI-FI access point device, and wherein the network identifier comprises a service set identifier (SSID).

28. The mobile terminal according to claim 25, wherein the at least one network device comprises a BLUETOOTH pairing device, and wherein the network identifier comprises BLUETOOTH device identification.

29. The mobile terminal according to claim 25, wherein the processor is further configured to:
determine whether the mobile terminal is in a missing claiming state by querying a network server when the correspondence between the current time period and the network identifier of the at least one network message received in the current time period does not comply with the correspondence stored in the database; and
perform an anti-theft operation when the mobile terminal is in the missing claiming state.

30. The mobile terminal according to claim 25, wherein the processor is further configured to perform an anti-theft operation when the correspondence between the current time period and the network identifier of the at least one network message received in the current time period does not comply with the correspondence stored in the database.

31. The mobile terminal according to claim 25, wherein the processor is configured to:
perform identity authentication for a holder of the mobile terminal when the correspondence between the current time period and the network identifier of the at least one network message received in the current time period does not comply with the correspondence stored in the database; and
perform an anti-theft operation when the identity authentication fails.

32.-33. (canceled)

34. The mobile terminal according to claim 29, wherein the anti-theft operation comprises at least one of: displaying specified information, locking the mobile terminal, deleting or encrypting stored user data, performing a positioning operation, or ringing.

35. The mobile terminal according to claim 25, wherein the database further stores a preset operation corresponding to the correspondence stored in the database, wherein the processor is further configured to perform the preset operation when the correspondence between the current time period and the network identifier of the network message received in the current time period complies with the correspondence stored in the database, and wherein the preset operation is associated with the correspondence stored in the database.

36. The mobile terminal according to claim 25, wherein the database stores the correspondence between the time period and the network identifier in a time sequence manner or in a network identifier classification manner.
